(19) United States
(12) Patent Application Publication
(10) Pub. No.: US 2005/0022418 A1
(43) Pub. Date: Feb. 3, 2005

(54) Method and device for drying flat objects, in particular gallium or silicon wafers or other like substrates

(76) Inventor: Werner Rietmann, Triboltingen (CH)

Correspondence Address: BACHMAN & LAPOINTE, P.C., 900 CHAPEL STREET, SUITE 1201, NEW HAVEN, CT, 06510, US

(21) Appl. No.: 10/494,454

(22) PCT Filed: Oct. 26, 2002
(86) PCT No.: PCT/EP02/11986

(30) Foreign Application Priority Data
Oct. 31, 2001 (DE) 101 53 225.3

(51) Int. Cl. F26B 3/00

(52) U.S. Cl. 34/493

(57) ABSTRACT

In a method of drying flat objects such as plate-shaped data storage media or semi-finished products thereof, in particular slices of gallium or silicon or like substrates, in a closable process chamber (30, 61) for receiving a carrier (12) that holds the substrate(s) (10), the substrates (10) are dipped into a bath (20) and can be moved within the spraying region of nozzles (50, 51, 52); the slice(s) (10) or the like is/are dipped into the bath (20) consisting of high-purity treatment liquid as separation medium (Q) and specifically lighter water, and a transverse current is generated by the separation medium at the bath surface (21) and the residual moisture is pushed off the bath surface. Moreover, the treatment liquid or the separation medium (Q) is cooled at room temperature; the temperature of the slice (10) or the like is kept above the ambient temperature, in particular about 5° C. above room temperature.

The invention relates to a method of drying flat objects such as plate-shaped data storage media or semi-finished products thereof, in particular slices of gallium or silicon or like substrates, as claimed in the preamble of patent claim 1. Moreover, the invention comprises a device which is particularly suitable for carrying out said method.

In the semiconductor industry, wafer drying is an essential process during the wet-chemical treatment of silicon slices. In the past, so-called rinser dryers have been designed as centrifuges, wherein particles have been generated on the contact surfaces of the silicon slices by the rotation on the bearings of the centrifuge and moreover by the pressing of the silicon slices into carrier grooves.

In a method according to DE 39 08 753 A1 by the Applicant, a number of slices or wafers are placed for cleaning and drying purposes in a carrier, are automatically removed from the carrier in a bath, and thereafter the slices are kept in the bath, in the relative position defined by the carrier, during the working procedure; the carrier releases the slices by immersing them to the deepest part of the bath, and the slices are received by support elements which pass through the carrier in the descending direction and project from the bottom of the container counter to the descending direction.

A generic device for the improved processing of silicon slices is disclosed in DE 40 40 132 A1 by the Applicant.

The slices are temporarily fixed by a holding-down clamp and are sprinkled in a rotating manner during the rotation and then dried by rotation under the effect of the centrifugal force. The drive shaft for the carrier holder is mounted on one side outside the process chamber, there being between the bearing thereof and the drum-like process chamber an annular space with a non-dragging labyrinth seal, which annular space is connected via a tolerated annular gap to the interior of the process chamber and issues from the connections for evacuating, cross-spraying and dewatering in order to be able to remove any particles that have penetrated in, especially abraded material caused by the bearing.

In current (very large scale integration) VSLI processes, this type of centrifugal drying is no longer important; a favorable drying method is the so-called Marangoni system, which is primarily used in high-tech semiconductor companies. In this system, the slices are drawn out of a warm DI water bath, and the residual moisture is stripped by the meniscus at the surface. In order to avoid back-condensation, an isopropanol vapor (IPA) is generated over the bath. This vapor is produced in an explosion-proof environment by heating IPA and the vapor carrier nitrogen over the bath. Nevertheless, IPA is not generally favorably used in chemistry since it is a medium with a risk of explosion.

Knowing these conditions, the inventor set himself the aim of configuring a method and a device of the type mentioned above with a simple design such that the acknowledged shortcomings of the prior art are avoided. It is provided to configure this procedure in a general manner for objects made of plastic, glass, ceramic, non-ferrous heavy metals or steel.

The teaching of the independent claim serves to achieve this object; the dependent claims provide favorable developments. Moreover, all combinations of at least two of the features disclosed in the description, the drawing and/or the claims fall within the scope of the invention.

According to the invention, the carrier is dipped or lowered into a bath which contains a high-purity treatment liquid as separation medium and specifically lighter water; a transverse current is generated by the separation medium at the bath surface, which transverse current displaces any residual moisture from the geometries of the substrates or slices off the bath surface into an overflow. This displaced medium is evacuated into a tank in which the film of water is separated from the medium and following a settling phase is passed for neutralization.

It is within the context of the invention to carry out the drying process without any vapor phase and to cool the treatment liquid; in order to obtain a greater specific weight different between the water and the separation medium and hence increase the effect of the stripping, according to the invention it is provided to cool the separation medium at room temperature and to keep the temperature of the substrate above the ambient temperature, in particular about 5° C. above room temperature. As a result, a specific weight difference of almost 1— in particular 0.5— can be achieved. However, cooling is only useful as long as the temperature of the wafer surface is not less than the dew point temperature of the ambient air. It has furthermore been found that in order to prevent condensation the wafer should ideally be about 5° C. warmer than the surrounding environment.

Advantageously, the bath should be exposed to ultrasound in order to be able to suppress the formation of bubbles on the substrates or slices and to remove small water droplets. The ultrasound increases the bath temperature, which is why cooling to clean-room ambient temperature+about 5° C. (for example 23° C.+5° C.=28° C. minimum temperature in the bath) is necessary.

Preferably, the treatment liquid should essentially be composed of highly volatile halogenated organic constituents, especially selected from the group consisting of partially fluorinated organic liquids, said group containing in particular partially fluorinated ethers—including hydrofluoroethers —, partially fluorinated alcohols and/or partially fluorinated hydrocarbons. In particular, the treatment liquid may consist essentially of isomers of methoxynonafluorobutyl ether or contain at least one alcohol, hydrocarbon or a ketone, or else a surface activator.

It has proven to be favorable to produce the treatment liquid from mixtures of isomers of methoxynonafluorobutyl ether with isopropanol, especially with about 1 to 7% by weight of isopropanol in the treatment liquid.

The separation medium is recirculated via a pump. An additional filtration of the separation medium at the inlet to the reservoir is also provided. The medium vaporized in the process reservoir is replaced via an additional metering pump from a reserve canister.

The device or system especially conceived for carrying out this method is distinguished in that the bath contains a high-purity separation medium as treatment liquid and is connected both to a tank for separating the medium from a film of water and to a coolant supply. According to a further feature of the invention, a container for the bath, which is arranged in the process chamber, is connected by means of a supply line to the tank and is also connected via further supply lines to spray nozzles arranged above the container. Said container for the bath should form with the process chamber a collecting space for discharge from the bath, wherein the collecting space is connected to the tank.

It has proven favorable to assign at least one ultrasonic generator to the reservoir or container, said ultrasonic generator preferably being fitted on the reservoir or container bottom, in order to allow the above-mentioned ultrasound exposure.

The abovementioned temperature adaptation may be carried out by virtue of a cover element—preferably designed as a sealing cover—which is assigned to the reservoir or container or process chamber and is connected to a refrigerating system—in particular a cryostat. Said refrigerating system is, however, also connected to the tank, in particular is connected by lines to at least one tube arranged in the tank, which tube preferably bears —bent in a serpentine-like manner—against the bottom of the tank.

The method according to the invention and the drier developed for that purpose are particularly suitable for use of the solvent 3 M HFE, which contains a significant proportion of methoxynonafluorobutanes. On account of the high specific weight of said HFE, during dipping of the substrates or wafers there occurs on the surface of the medium a stripping of the residual moisture and a good meniscus formation, so that most of the final rinse water H₂O-DI—deionized water—on the surface is stripped off. In order to reduce the affinity of the residual moisture for structured wafers, small amounts of isopropanol are added to the HFE. The amount added depends on the surface structure and also on whether the wafers are hydrophobic or hydrophilic.

Further advantages, features and details of the invention emerge from the following description of preferred examples of embodiments and with reference to the drawing; in the drawing:

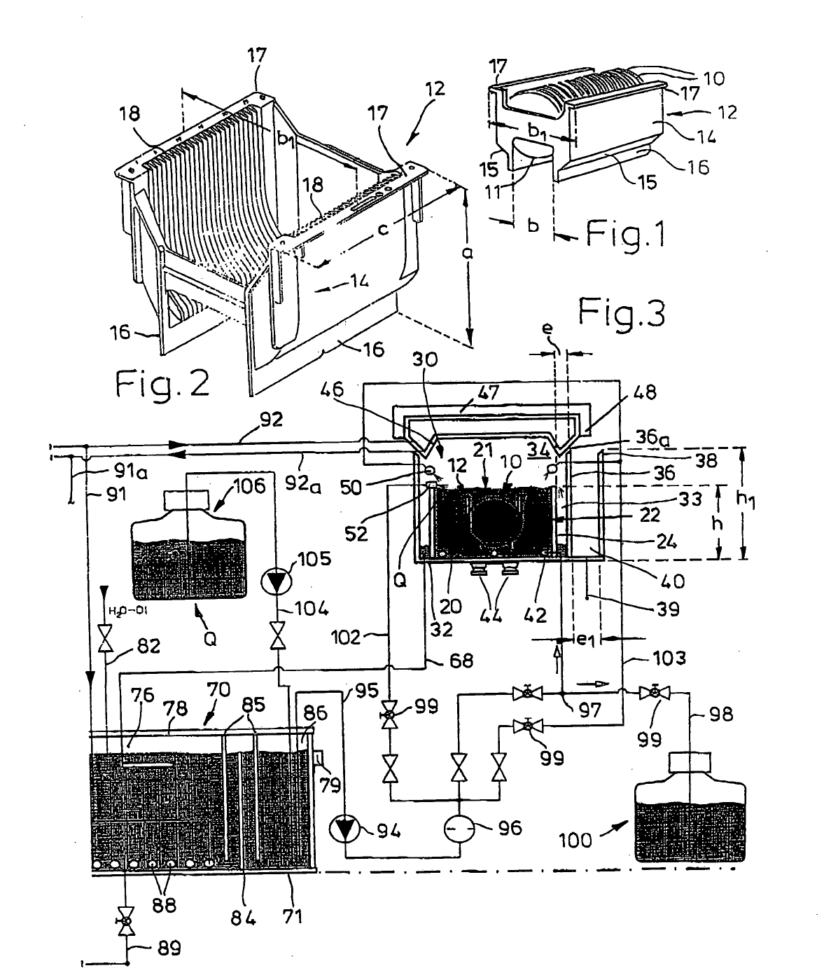

FIGS. 1, 2 in each case show an oblique view of a carrier for slices of silicon,

FIG. 3 shows part of a flow diagram of a method according to the invention with a device, which receives the carrier, for drying the slices;

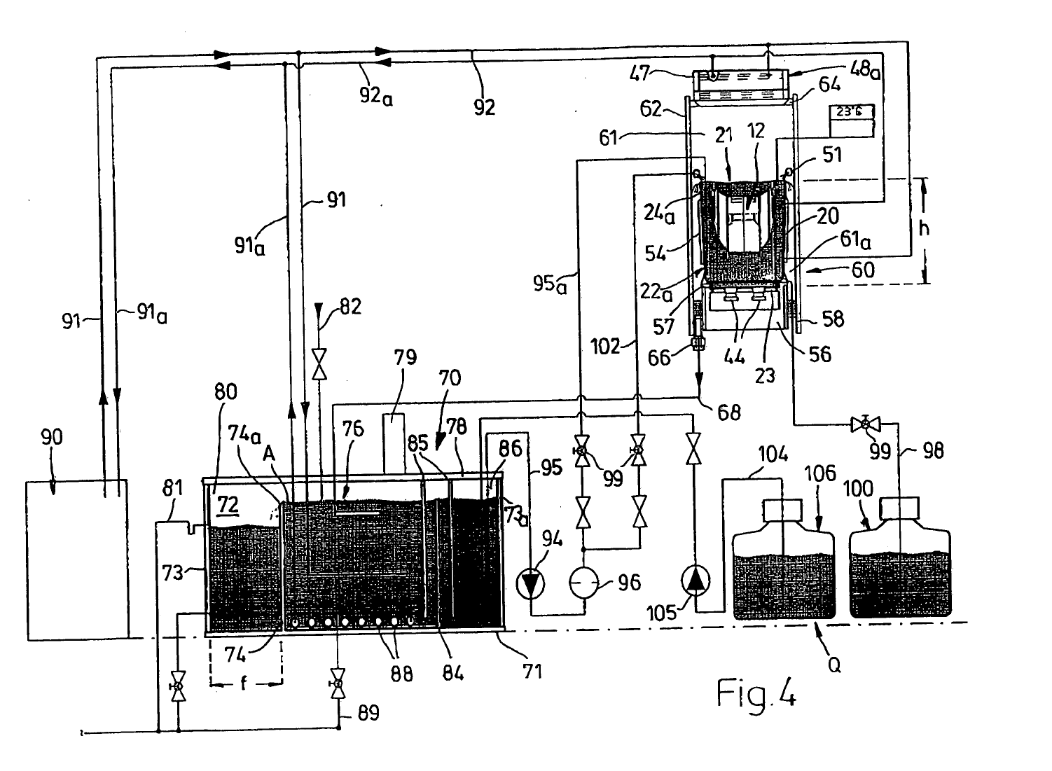

FIG. 4 shows the entire flow diagram with a further design of the drying device;

FIG. 5 shows a partially cut-away side view of a drying device for slices comprising a tank, acting as base, under a process chamber;

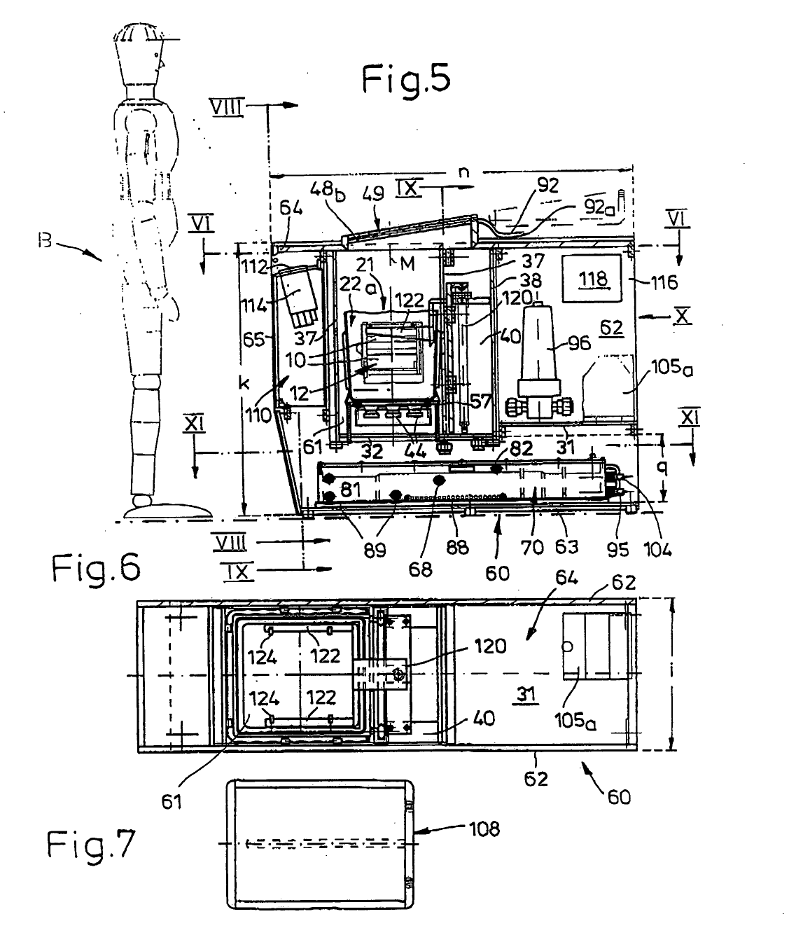

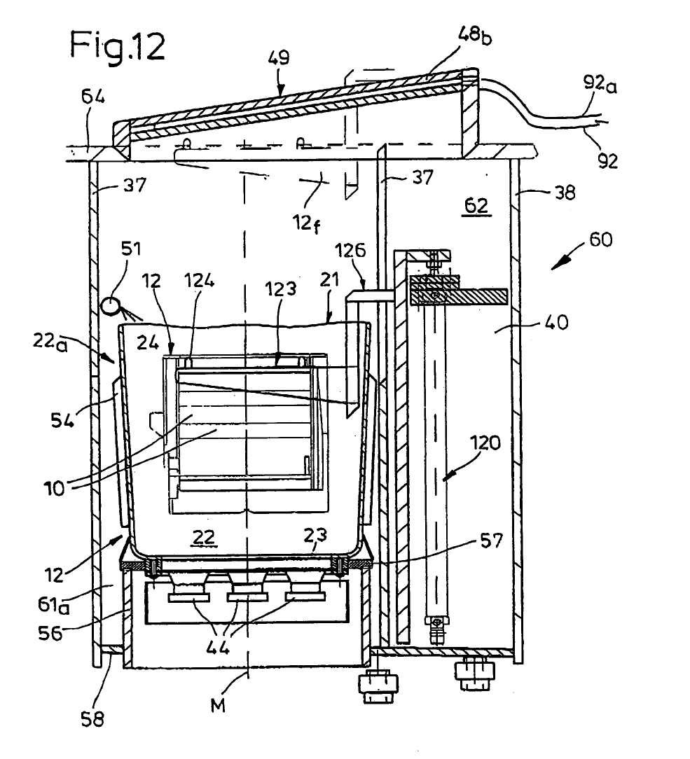

FIGS. 6, 11 show enlarged longitudinal sections through FIG. 5 along lines VI-VI and XI-XI thereof, respectively;

FIG. 7 shows the plan view of an add-on element assigned to FIG. 6;

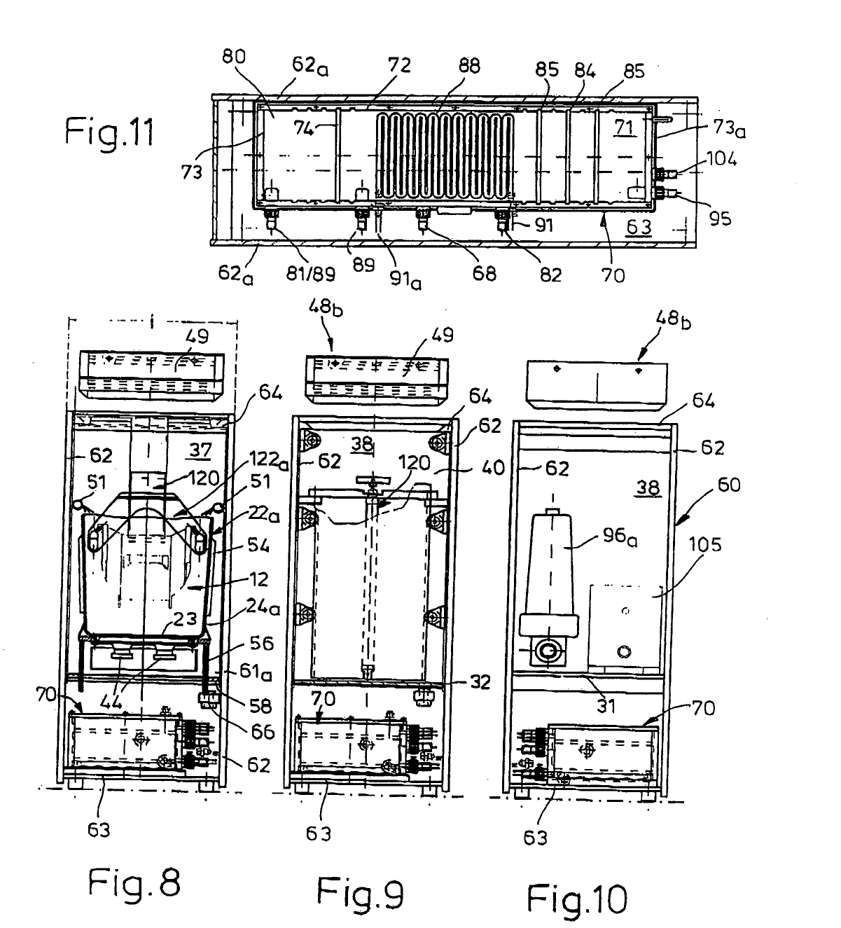

FIGS. 8, 9 show cross sections through FIG. 5 along lines VIII-VIII and IX-IX thereof, respectively;

FIG. 10 shows an end view of FIG. 5 in the direction of arrow X;

FIG. 12 shows an enlarged detail from FIG. 5;

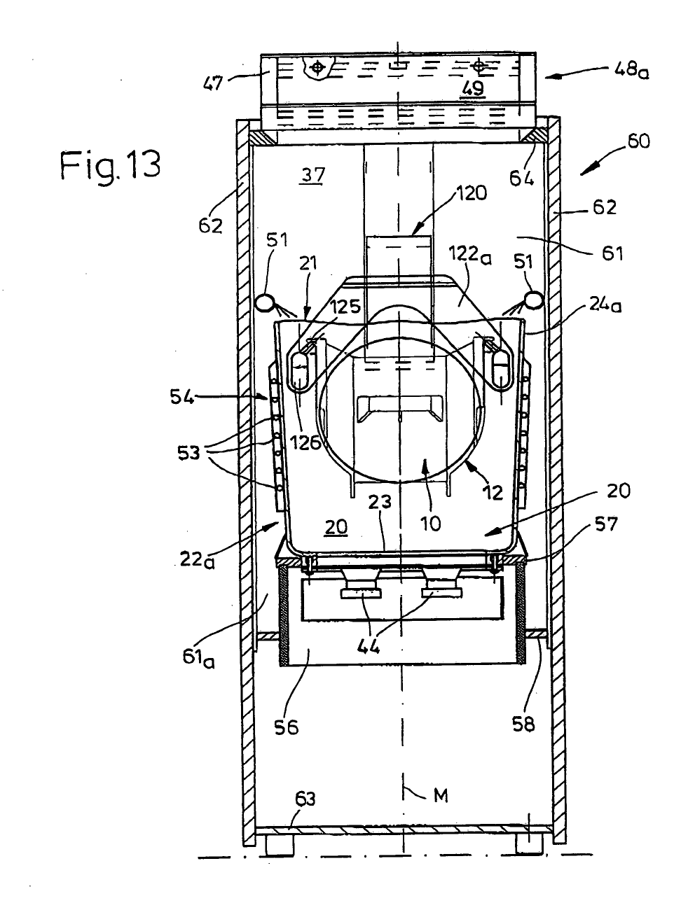

FIG. 13 shows an enlarged representation of parts of FIG. 8;

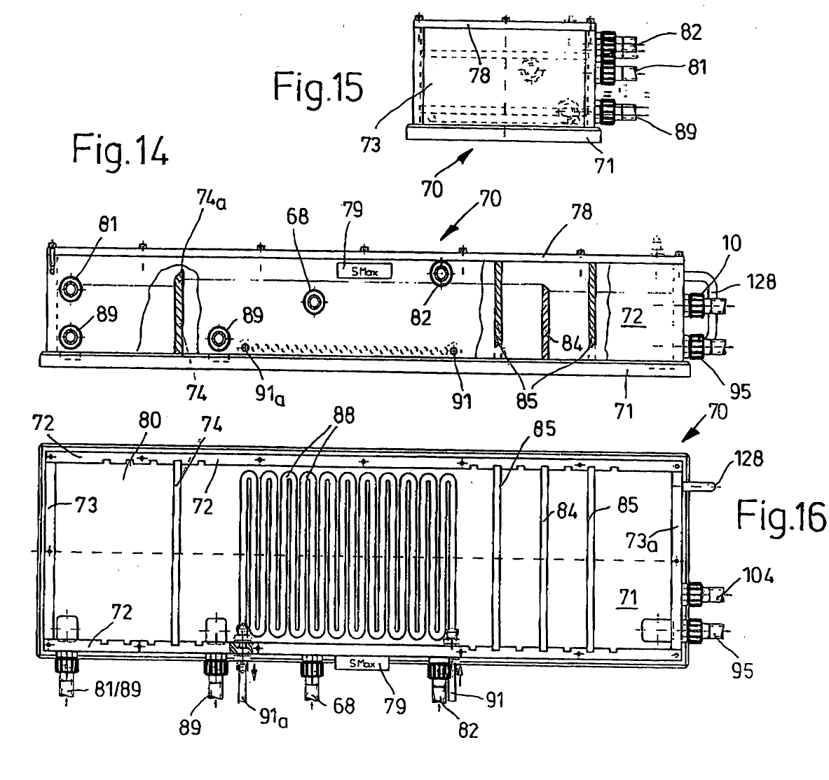

FIG. 14 shows an enlarged side view of the tank of FIG. 5;

FIG. 15 shows an end view of FIG. 14;

FIG. 16 shows the plan view of the tank of FIG. 14.

In order to dry slices 10 of gallium or silicon—so-called wafers—the latter are placed as shown in FIG. 1 parallel to one another in a carrier 12 which is approximately H-shaped in cross section and has an open top side. This carrier 12 for wafers 10, which in this case measure 200 mm, has a height a of about 220 mm and is provided on the inner faces of its side walls 14 having a length c of in this case 205 mm with receiving grooves 18 for the slices 10, the respective circumference 11 of which slices is uncovered both in the direction of said top face and toward the bottom between two baseboards 16 of the side walls 14. Adjoining the baseboards 16, which run at an inner spacing b of about 115 mm with respect to one another, there are shoulder faces 15 which are inclined outward and act as a transition to the side walls 14. The outer spacing b₁ of top strips 17, which are integrally formed on the top edges of the side walls 14 and protrude laterally from the latter, measures about 235 mm.

For wafer drying, the carrier 12 is lowered into a bath 20 which contains a high-purity treatment liquid as separation medium for removing water adhering to the slices 10; this treatment liquid is specifically heavier than water. The bath 20 is located in a reservoir or container 22 having the height h of a process chamber 30; from the baseplate 32 thereof there project in FIG. 3 two parallel container walls 24 and, beside the latter at a spacing e, two chamber walls 36 which project beyond said container walls 24 and delimit with the latter in each case one side chamber 33 of the interior 32. Assigned to the right-hand chamber wall 36 in FIG. 3, at a spacing e₁, is an additional parallel outer wall 38 of the same height h₁ which likewise projects from the baseplate 32 and delimits a special lifting chamber 40 comprising an underlying outlet device 39.

On the baseplate 32 there run flow tubes 42, the significance of which will be described further below. A number of ultrasonic generators or ultrasonic transmitters 44 project downward from the baseplate 32 outside the interior 34; the ultrasound transmitted to the reservoir 22 should prevent the formation of water bubbles on the slices 10.

Assigned to the inwardly inclined top edges 36ₐ of the chamber walls 36 is a—correspondingly inclined—outer wall of a collar 46 of a sealing cover 48 which has an outer insulating layer 47, said collar being triangular in cross section.

The specifically lighter water on the surface 21 is stripped off by virtue of the dipping of the slices 10. For the procedure of moving them in or out, additional spray nozzles 50 are fitted in the interior 34 of the process chamber 30 in order to remove any residual moisture from the geometries of the slices 10.

Assigned to the left-hand row of spray nozzles 50 in FIG. 3, on the adjacent container wall 24, is a flow guide 52 which guides a horizontal jet of treatment liquid or separation medium Q—for example selected from the group consisting of partially fluorinated organic liquids, in particular partially fluorinated ethers (including hydrofluoroethers), partially fluorinated alcohols and partially fluorinated hydrocarbons—over the bath surface 21 or the bath level. In this way, a transverse current is generated by the separation medium Q at the bath surface 21, said transverse current displacing the residual moisture from the bath surface 21 into the side chambers 36 which act as an overflow trough.

In the embodiment shown in FIG. 4, the reservoir or container 22ₐ is designed in a pot-shaped manner with the height h; an outwardly inclined container wall 24ₐ is integrally formed on an approximately quadriform reservoir bottom 23 and surrounded by a flow jacket 54 which contains flow tubes 53 as shown in FIG. 12.

Ultrasonic transmitters 44 are also assigned to the reservoir bottom 23, which ultrasonic transmitters are in this case surrounded by a sleeve tube 56; the latter projects from a baseplate 57 assigned to the reservoir bottom 23 and is supported by means of a radial base ring 58 against the parallel side walls 62 of a housing 60 which is covered at the top by a cover plate 64. The side walls 62 delimit with the base ring 58, the sleeve tube 56 and the reservoir or container 22ₐ a side space 61ₐ of the housing interior 61, which side space surrounds said reservoir or container. The housing interior is covered by the cooling cover 48ₐ which is seated in the insulating cover plate 64 and is likewise surrounded by an outer insulating layer 47.

Above the side chamber or side space 61ₐ, spray nozzles 51 are assigned to the edge area of the container 22ₐ, the spray jet of which nozzles, which is directed at the bath level 21, rinses the latter of treatment liquid or separation medium Q. Said treatment liquid or separation medium collects in the deepest part of the side space 61ₐ, which is delimited by the base ring 58, the sleeve tube 56 and the side wall 62; this is because a transverse current is generated by the separation medium Q at the bath surface 21 on account of the spray jet of the spray nozzles 51, as happened in FIG. 3 on account of the abovementioned flow guide 52, which transverse current displaces the residual moisture from the bath surface 21 into the side spaces 61ₐ which act as an overflow chamber.

The displaced treatment liquid Q is discharged by a line 68— which in FIG. 4 is connected to an outlet 66 of the base ring 58 for the side space 61ₐ—to a tank 70, in a collecting space 76 of which, which is delimited by a tank bottom 71, longitudinal walls 72 and side walls 73 and 73ₐ, a film of water A is removed from the treatment liquid Q and after a settling phase in a lateral water chamber 80 is fed for neutralization through a discharge 81.

The tank 70 contains, at a spacing f from the outer wall 73 which delimits the water or settling chamber 80, a weir wall 74 which divides its interior or collecting space 76 and has a downwardly inclined top edge 74ₐ over which said film of water A is discharged. Assigned to the latter, moreover, is a line 82 for H₂O-DI, in order to be able where necessary to rinse the tank 70. Near the other outer wall 73ₐ of the tank 70 there projects from the tank bottom 71 a transverse wall 84 which ends at a distance from the top plate 74 and has flank walls 85 provided at a distance on both sides; the latter are directed downward from the top plate 78—which is equipped with an external sensor 79—and end at a distance from the tank bottom 71, as a result of which a labyrinth-like flow path acting as separator is produced between said collecting space 76 of the tank 70 and an antechamber 86—which is delimited by the right-hand outer wall 73ₐ in FIGS. 3, 4.

As already mentioned, overflow from the reservoir 22, 22ₐ flows through the line 68 to the tank 70. Moreover, a coolant passes from a cryostat 90 through a line 91 to a serpentine-like bottom tube 88 of the tank 70 which is arranged next to an outflow 89; a branch line 92 leads further to the coolable sealing cover 48, 48ₐ for the process chamber 30 and the housing 60. The return lines which work in the opposite direction are referenced 91ₐ and 92ₐ, respectively. The cryostat 90 is a device intended for the automatic setting of deeper temperatures with the aid of a gas or a refrigerating mixture; in order to obtain a greater specific weight difference between the water A and the treatment liquid Q—and thus increase the effect of the stripping—it is provided to cool the treatment liquid or separation medium at room temperature. A specific weight difference of almost 1 can thereby be achieved.

The treatment liquid Q is recirculated via a pump 94 through a supply line 95 or is fed back in FIG. 3 to the flow or bottom tubes 42 in the bath 20 and in FIG. 4 directly at 95ₐ to the bath 20; the line 95 contains, for additional filtration at 96, a 12″ 0.1 μm filter and in FIG. 3 receives at a junction 97 a branch line 98 which —with the interconnection of a tube blocking member 99—is guided to an outflow container 100. In FIG. 4, the line 98 of the outflow container 100 is directly connected to the reservoir or container 22ₐ. A further branch line 102 connects the line 95 to the spray nozzles 51 or flow guide 52. In the example of FIG. 3, there is yet another branch line 103 which is connected at the other end to the high-lying spray nozzles 50 shown there above the flow guide 52.

Besides the line 95, a further line 104 ends in the antechamber 86 of the tank 70, by virtue of which line 104 the separation medium Q vaporized in the bath 20 can be replaced via an additional metering pump 105 from a reserve canister 106.

FIGS. 5 ff. show a housing 60 with side walls 62 having a length n of 1200 mm and a height k of 1000 mm; the housing width i in this case measures 400 mm. In the housing 60 there can be seen at 22ₐ the process reservoir with slices 10 lying horizontally in a carrier 12; the baseplate 32 runs at a spacing q from a housing bottom 63, on which the tank 70 rests. The side walls 62 project from the housing bottom 63 as baseplate and together bear the housing cover plate 64 in which there are arranged a multilayer cooling or sealing cover 48_{b} with inclined lean-to surface 49 and supply and return lines 92, 92ₐ for the cover refrigeration. The baseplate 32 is held against the cover plate 64 of the housing 60 by transverse walls 37 and an outer wall 38. A slide cover 108 for covering the interior 61 is shown in FIG. 7.

Below the sealing cover 48_{b} there run said transverse walls 37 and said outer wall 38 which delimit both the abovementioned side spaces 61ₐ and the lifting chamber 40. On one end side of the housing 60 there is, facing a user B, behind an end wall 65, an electrical cabinet 110 with an inclined display 112 of a computer 114, which electrical cabinet may be screwed shut or provided with hinges such that it may be opened and closed; on the other end side, a filter 96ₐ, compressed air valves 118 and a pump 105ₐ are arranged in a rear chamber 116 on a support base 31.

FIG. 12 in particular shows a lifting column 120 with supporting arms 122 which project radially to the side and in each case comprise a horizontal angled piece, which lifting column 120 runs in the lifting chamber 40 parallel to the vertical axis M of the reservoir 22, 22ₐ; on the horizontal faces 123 of said supporting arms there are buffer or like latching elements 124 on which the carrier 12 rests, which carrier can in this way be held and lowered from a top position 12_{f} and raised again to this position.

FIG. 13 shows that the carrier 12 is grasped by angled arms 122ₐ of the lifting column 120 which are designed like a roof in cross section and grasp the top strips 17 of the carrier 12 by supporting profiles 125 of transverse rods 126 which are inclined downward and outward with respect to one another and to the vertical axis M.

Provided on the tank 70 in FIGS. 5, 11 and 14 to 16 in the front wall 72 are connections for the neutral discharge 81 from the settling chamber 80, for the outflow 89, the lines 91, 91ₐ of the cryostat 90 to the bottom tube 88, the line 68 from the process reservoir 22ₐ, the H₂O-DI line 82 and at the side the suction line 95 to the pump 94 and the threaded connection 104. Reference numeral 128 designates another filling level line.

1. A method of drying flat objects such as plate-shaped data storage media or semi-finished products thereof, in particular slices of gallium or silicon or like substrates, in a closable process chamber (30, 61) for receiving a carrier (12) that holds the substrate(s) (10), wherein the substrates are dipped into a bath (20) and can be moved within the spraying region of nozzles (50, 51, 52), characterized in that the slice(s) (10) or the like is/are dipped into the bath (20) consisting of high-purity treatment liquid as separation medium (Q) and specifically lighter water, and in that a transverse current is generated by the separation medium at the bath surface (21) and the residual moisture is pushed off the bath surface.

2. The method as claimed in claim 1, characterized in that the treatment liquid or the separation medium (Q) is cooled at room temperature.

3. The method as claimed in claim 1 or 2, characterized in that the temperature of the slice (10) or the like is kept above the ambient temperature, in particular about 5° C. above room temperature.

4. The method as claimed in any of claims 1 to 3, characterized in that a transverse current is generated at the bath surface (21) by at least one spray nozzle (51, 52) [lacuna] an approximately horizontal jet of treatment liquid or separation medium (Q).

5. The method as claimed in claim 4, characterized in that residual moisture is pushed off the bath surface by the transverse current.

6. The method as claimed in any of claims 1 to 5, characterized by a treatment liquid (Q) which is essentially composed of highly volatile halogenated organic constituents.

7. The method as claimed in claim 1 or 6, characterized by a treatment liquid (Q) selected from the group consisting of partially fluorinated organic liquids, said group containing in particular partially fluorinated ethers, partially fluorinated alcohols and/or partially fluorinated hydrocarbons.

8. The method as claimed in claim 7, characterized by a treatment liquid (Q) consisting essentially of isomers of methoxynonafluorobutyl ether.

9. The method as claimed in claim 8, characterized in that the treatment liquid (Q) contains at least one alcohol, hydrocarbon or a ketone.

10. The method as claimed in claim 8, characterized in that the treatment liquid (Q) contains a surface activator.

11. The method as claimed in claim 9, characterized in that the treatment liquid (Q) consists of mixtures of isomers of methoxynonafluorobutyl ether with isopropanol.

12. The method as claimed in claim 11, characterized by 1 to 7% by weight of isopropanol in the treatment liquid.

13. The method as claimed in any of claims 1 to 12, characterized in that ultrasound is passed into the bath (20) during the drying process.

14. The method as claimed in claim 13, characterized in that bubble formation on the slice (10) or the like is prevented by means of the ultrasound.

15. The method as claimed in claim 13, characterized in that water droplets are removed from the slice (10) or the like by means of the ultrasound.

16. The method as claimed in any of claims 1 to 5, characterized in that the water fractions (A) are withdrawn from the liquid pushed off the bath surface (21) into a tank (70) or like device.

17. The method as claimed in any of claims 1 to 16, characterized in that the specifically lighter water is stripped off at the surface of the liquid.

18. The method as claimed in claim 16 or 17, characterized in that the liquid in the tank (70) is cooled at room temperature.

19. The method as claimed in claim 17 or 18, characterized in that H₂O-DI is fed to the tank (70) for rinsing purposes.

20. The method as claimed in any of claims 1 to 19, characterized in that the drying process is carried out without a vapor phase.

21. A device for drying flat objects such as plate-shaped data storage media or semi-finished products thereof, in particular slices of gallium or silicon or like substrates, in a closable process chamber (30, 61) for receiving a carrier (12) that holds the slices (10) or the like, wherein the slice(s) (10) or the like is/are dipped into a bath (20) and can be moved within the spraying region of nozzles (50, 51, 52), in particular for carrying out the method as claimed in at least one of the preceding claims, characterized in that the bath (20) contains a high-purity separation medium as treatment liquid (Q) and is connected both to a tank (70) for separating the medium from a film of water (A) and to a coolant supply (90, 91, 92).

22. The device as claimed in claim 21, characterized in that a container (22, 22ₐ) for the bath (20), which is arranged in the process chamber (30, 61), is connected by means of a supply line (95, 95ₐ) to the tank (70) and is also connected via further supply lines (102, 103) to spray nozzles (51, 52, 50) arranged above the container.

23. The device as claimed in claim 21 or 22, characterized in that the container (22, 22ₐ) for the bath (20) forms with the process chamber (30, 61) a collecting space (33, 61ₐ) for discharge from the bath, wherein the collecting space is connected to the tank (70).

24. The device as claimed in any of claims 21 to 23, characterized in that at least one ultrasonic generator (44) is assigned to the reservoir or container (22, 22ₐ), said ultrasonic generator preferably being fitted on the reservoir or container bottom (23, 32).

25. The device as claimed in any of claims 21 to 24, characterized in that a cover element (48, 48ₐ, 48_{b}) is assigned to the reservoir or container (22, 22ₐ) or process chamber (30, 61), said cover element being connected to a refrigerating system, in particular a cryostat (90).

26. The device as claimed in claim 25, characterized in that the cover element is designed as a sealing cover (48, 48ₐ, 48_{b}).

27. The device as claimed in claim 25 or 26, characterized in that the refrigerating system (90) is connected to the tank (70), in particular is connected by lines (91, 91ₐ) to at least one tube (88) arranged in the tank.

28. The device as claimed in any of claims 21 to 27, characterized in that the interior of the tank (70) is divided by a weir wall (74) into a collecting space (76) and a settling space (80) for a film of water (A) that has entered over the weir wall.

29. The device as claimed in claim 28, characterized in that the collecting space (76) separates a labyrinth zone, which is of meandering cross section, from a discharge area for treatment liquid (Q) which is connected to the container (22, 22ₐ).

30. The device as claimed in any of claims 21 to 29, characterized in that the container (22, 22ₐ) is arranged in a housing (60) and a lifting device (120 to 122) is assigned to the latter.
